(19) United States
(12) Patent Application Publication
(10) Pub. No.: US 2020/0331194 A1
(43) Pub. Date: Oct. 22, 2020

(54) ADDITIVE MANUFACTURING WITH GLASS

(71) Applicant: Bemis Company, Inc., Neenah, WI (US)

(72) Inventors: Daniel C. Vennerberg, Neenah, WI (US); Rebecca M. Mick, Appleton, WI (US); Ryan A. Michaud, Winneconne, WI (US)

(21) Appl. No.: 16/957,335

(22) PCT Filed: Dec. 26, 2017
(86) PCT No.: PCT/US2017/068395

§ 371 Date: Jun. 23, 2020

(51) Int. Cl. B29C 64/106; B29C 64/209; B29C 64/227; G06T 17/00; B29C 64/245; C03C 3/247; B29C 64/295

(52) U.S. Cl. CPC B29C 64/106; B29C 64/209; B29C 64/227; B33Y 10/00; B29C 64/245; C03C 3/247; B29C 64/295; G06T 17/00

(57) ABSTRACT

An additive manufacturing method includes heating a glass having a glass transition temperature (T_{g}) of about 500° C. or less, flowing the heated glass through a nozzle onto a platform, and moving the nozzle relative to the platform while the heated glass is flowed through the nozzle onto the platform to form an object on the platform.

### FIELD

The invention relates to additive manufacturing using glass.

### BACKGROUND

Additive manufacturing, also known as 3D printing, has gained popularity in the last decade. There are numerous techniques that can be employed for 3D printing. For plastics, these techniques include fused deposition modeling (FDM), stereolithography, digital light processing, continuous light processing, selective laser sintering (SLS), multi-jet fusion, and material jetting. Of these processes, FDM is the most common.

Additive manufacturing has been commonly used for a variety of polymers, metals, and ceramics. The use of glass has proven to be elusive until recently when “liquid glass” was used in a material jetting 3D printer. The liquid glass contained silica glass nanoparticles mixed with photocurable polymer. An object was printed and then annealed at an elevated temperature to fuse the glass nanoparticles into the printed shape and to burn off the polymer.

While effective for 3D printing of such liquid glass, material jetting processes and equipment are not as common as FDM and SLS. In addition, the post-printing annealing step required for printing of such liquid glass may consume a substantial amount of time and energy.

### SUMMARY

Described herein, among other things, is additive manufacturing using glass having a low glass transition temperature (T_{g}). The low T_{g} glass may be extruded and deposited in an additive manufacturing process in a temperature range similar to printed polymeric material, allowing the use of more common additive manufacturing processes and equipment, such as FDM and SLS. In addition, post-printing annealing may be unnecessary in additive manufacturing employing low Tg glass as described herein. Further, the low T_{g} glass may be printed without the use of a binding aid.

In various embodiments of the invention, an additive manufacturing method includes heating a glass having a T_{g} of about 500° C. or less, flowing the heated glass through a nozzle onto a platform, and moving the nozzle relative to the platform while the heated glass is flowed through the nozzle onto the platform to form an object on the platform. The glass may comprise an alkali phosphate glass, such as a tin fluorophosphates glass. Preferably, the glass has a T_{g} of about 300° C. or less, such as from about 180° C. to about 280° C.

The invention also includes objects manufactured according to the processes described herein. Such objects are formed from glass having a T_{g} of about 500° C. or less. Any suitable object may be formed according to the processes described herein, with the assortment of feasible objects only being limited by the 3D printing technique employed.

The invention further includes, in combination, additive manufacturing equipment and a low T_{g} glass when used with the equipment.

### BRIEF DESCRIPTION OF THE DRAWINGS

Further features and advantages of the present invention will become apparent from the following detailed description, taken in combination with the appended drawings, in which:

FIGS. 1-3 are flow diagrams of embodiments of methods described; and

FIGS. 4A-4B are schematic diagrams illustrating an embodiment of additive manufacturing components used in an illustrative additive manufacturing process.

### DETAILED DESCRIPTION OF ILLUSTRATIVE EMBODIMENTS

The methods, systems, and articles of the invention include a glass having a low T_{g}. Due to the low T_{g}, the glass may be used in additive manufacturing processes and equipment for which polymers having a similar T_{g} are employed. Accordingly, any suitable additive manufacturing process, such as FDM, stereolithography, digital light processing, continuous light processing, SLS, multi-jet fusion, and material jetting, may be used to form glass objects having a low T_{g} as described herein. Thus, any suitable low T_{g} glass object may be formed. In many cases, the structure of the low T_{g} glass object that is formed is limited only by the additive manufacturing method and equipment employed.

The glass used in the additive manufacturing process and the resulting glass object have a low T_{g}. For example, the glass may have a glass transition temperature, T_{g}, of about 500° C. or less, about 300° C. or less, or about 200° C. or less. For example, the glass transition temperature may be less than 500° C., less than 400° C. less than 350° C. less than 300° C., less than 250° C., less than 200° C., or less than 150° C. In some embodiments, the T_{g} of the glass is in a range from about 180° C. to about 280° C. In some embodiments, the glass is an alkali phosphate glass. In some embodiments, the glass is a tin fluorophosphate glass (sometimes referred to as “SnF-glass”). Such glasses may be made by batch melting of inorganic materials such as, but not limited to, BaF₂, SnF₂, ZnF₂, P₂O₅, Sn(PO₄)₂, SnO, Sn₂P₂O₇, SnCl₂, NH₄H₂PO₄, NH₄F, and NH₄PF₆, and may be melted at temperatures not exceeding 600° C. (typically in the range within 400° C. and 500° C.) to provide homogenous glasses of good quality and relatively high chemical durability. Other exemplary glasses include, but are not limited to copper oxide glasses, tin oxide glasses, silicon oxide glasses, tin phosphate glasses, chlorophosphate glasses, chalcogenide glasses, tellurite glasses, borate glasses, bismuth oxide glasses, and combinations thereof.

In some embodiments, the glass used in the additive manufacturing process and the resulting glass object have a composition comprising, on an elemental basis, tin in a mole percentage of at least 7.4, at least 12.0, or at least 15.4, and at most 17.1 or at most 30.0.

In some embodiments, the glass used in the additive manufacturing process and the resulting glass object have a composition comprising, on an elemental basis, fluorine in a mole percentage of at least 4.9, at least 11.2, or at least 19.6, and at most 24.3 or at most 47.2.

In some embodiments, the glass used in the additive manufacturing process and the resulting glass object have a composition comprising, on an elemental basis, phosphorus in a mole percentage of at least 6.7, at least 12.1, or at least 14.2, and at most 16.6, at most 19.6, or at most 23.1.

In some embodiments, the glass used in the additive manufacturing process and the resulting glass object have a composition comprising, on an elemental basis, oxygen in a mole percentage of at least 20.8, or at least 43.3, and at most 56, at most 61.1, or at most 61.5.

In some embodiments, the glass used in the additive manufacturing process and the resulting glass object have a composition comprising, on an elemental basis, tin in a mole percentage within a range of 7.4 to 30, fluorine in a mole percentage within a range from 4.9 to 47.2, phosphorus in a mole percentage within a range from 6.7 to 23.1, and oxygen in a mole percentage within a range from 20.8 to 61.5. In some embodiments, the glass may have a composition comprising, on an elemental basis, tin in a mole percentage within a range from 12 to 17.1, fluorine in a mole percentage within a range from 11.2 to 24.3, phosphorus in a mole percentage within a range from 12.1 to 19.6, and oxygen in a mole percentage within a range from 43.3 to 61.1. In some embodiments, the glass may have a composition comprising, on an elemental basis, tin in a mole percentage within a range from 15.4 to 17.1, fluorine in a mole percentage within a range from 19.6 to 24.3, phosphorus in a mole percentage within a range from 14.2 to 16.6, and oxygen in a mole percentage within a range from 43.3 to 56. In some embodiments, additional elements are present in the glass composition, including, for example, tungsten or niobium.

The qualitative and quantitative determination of the elemental components of the glass used in the additive manufacturing process and the resulting glass object may be determined by energy dispersive x-ray (EDX) spectrometric analysis. EDX spectrometric analysis techniques of inorganic compositions are well-known and can be readily performed by those skilled in the art without undue experimentation.

The T_{g} of the glass used in the additive manufacturing process and the resulting glass object may be determined in any suitable manner. For example, the T_{g} may be determined as described in ASTM E1356-08(2014), Standard Test Method for Assignment of the Glass Transition Temperatures by Differential Scanning Calorimetry, ASTM International, West Conshohocken, Pa., 2014.

The low T_{g} glass input into the additive manufacturing apparatus may be in any suitable form. For example, the glass may be in the form of a solid nuggets, powder, raw material for glass, a rod, an ingot, a filament, a molten form melted by another apparatus, or the like. The input glass may be heated until the glass flows or is flowable under pressure, such as with extrusion. For example, the glass may be heated to a temperature between 80° C. to 400° C. and be used with additive manufacturing processes and equipment for which polymers are employed. In some embodiments, the glass is heated to a temperature that is between 10° C. to 100° C. above the T_{g} of the glass composition.

The heated glass may then be flowed through a nozzle of the additive manufacturing apparatus onto a platform where the low T_{g} glass object is formed. For purposes of the present disclosure, a glass that is “flowed” through a nozzle may be a glass that freely flows through the nozzle or a glass that is forced to flow through the nozzle under pressure, such as extruding the glass through the nozzle.

The nozzle may be moved relative to the platform to dispose the heated glass on the platform in a predetermined manner, such as based on a computer-based three-dimensional model of the object. The low T_{g} glass object formed on the platform may be formed layer-by-layer. In other words, a first layer of low T_{g} glass may be disposed on the platform, the platform may be displaced a predetermined distance from the nozzle, and a second layer may be disposed on the deposited first layer, and so on. When the final layer of low T_{g} glass is deposited, the object may be suitable for use without further annealing, due to the low T_{g} of the glass.

Moving the nozzle relative to the platform may be accomplished by moving at least one of the nozzle or the platform. The nozzle may move and the platform is stationary the nozzle may be stationary and the platform moves, or both the nozzle and the platform may move. The phrase “moving the nozzle relative to the platform” includes any of these variations and does not require that the nozzle move.

Any suitable additive manufacturing apparatus and process may be employed. Examples of suitable apparatuses and processes include those described in, for example, US 2017/0081236 A1, published on Mar. 23, 2017; U.S. Pat. No. 5,121,329, used on Jun. 9, 1992; and U.S. Pat. No. 4,575,330, issued on Mar. 11, 1986, each of which is hereby incorporated herein in their respective entireties to the extent that they do not conflict with the disclosure presented herein. US 2017/0081236 A1 discloses that post-printing annealing may be required. However, such annealing should not be required for the processes described herein, which employ T_{g} glass. Otherwise, the processes and apparatuses described in US 2017/0081236 A1 may be generally employed with the low T_{g} glass described herein.

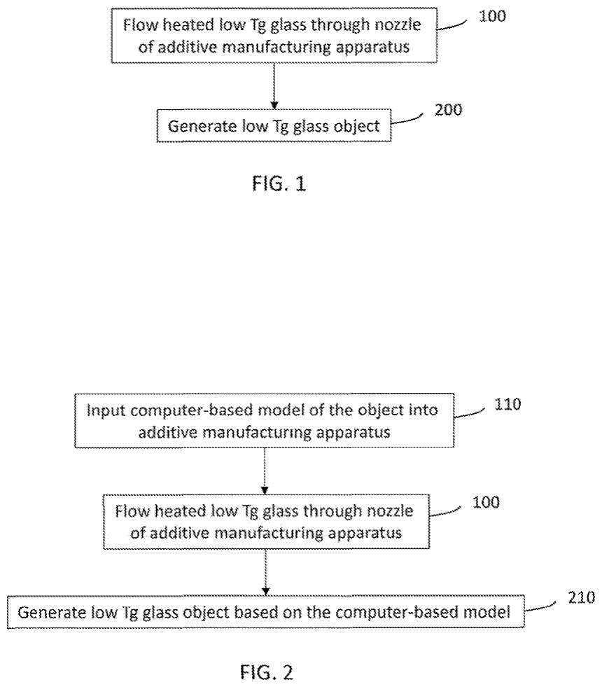

FIG. 1 is a flow diagram of an overview of a method of the invention. The method includes flowing heated low T_{g} glass through a nozzle of an additive manufacturing apparatus (100) to generate a three-dimensional low T_{g} glass object (200).

As shown in FIG. 2, data regarding a computer-based model of the object to be manufactured may be input into the additive manufacturing process (110) and heated low T_{g} glass may be flowed through a nozzle of an additive manufacturing apparatus (100) to generate a three-dimensional low T_{g} glass object based on the computer-based model (210). For purposes of the present disclosure, inputting data regarding a computer-based model of the object to be manufactured includes generating the model of the object with a computer that is part of the additive manufacturing apparatus; generating the model of the object with a computer that is separate from the additive manufacturing apparatus and inputting data regarding the model into the additive manufacturing apparatus, or the like.

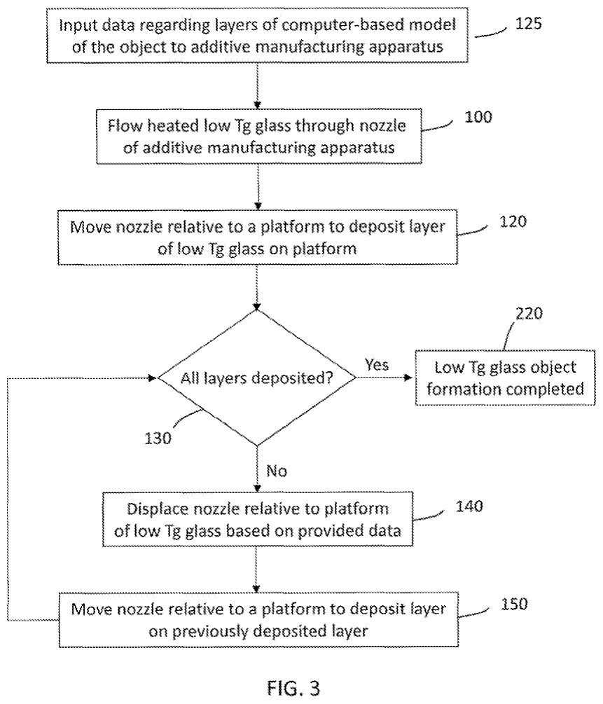

FIG. 3 is a flow diagram of an embodiment of a method of the invention. The method includes inputting data regarding layers of a computer-based model of the object to be manufactured to the additive manufacturing apparatus (125). Inputting data regarding the layers of the computer-based model includes generating the data regarding the layers with a computer that is part of the additive manufacturing apparatus; generating the layers with a computer that is separate from the additive manufacturing apparatus and inputting data regarding the model into the additive manufacturing apparatus, or the like. The method further includes flowing heated low T_{g} glass through a nozzle of the additive manufacturing apparatus (100) and forming the object layer by layer. For example, the nozzle may be moved relative to a platform on which the glass is deposited (120) so that a layer is formed on the platform based on the data regarding the layers of the computer based model of the object. If additional layers of low T_{g} glass are to be deposited (130), the nozzle may be displaced (moved a distance away from) the platform a predetermined amount (140), such as a distance about the thickness of the previously deposited layer. The nozzle may be moved, such as in a plane parallel to a surface of the platform, to deposit an additional layer of low T_{g} glass on the previously deposited layer, based on the data regarding the layers of the computer based model of the object. The process (130-150) may be repeated until all the low T_{g} glass layers are deposited and formation of the low T_{g} glass object is completed (220).

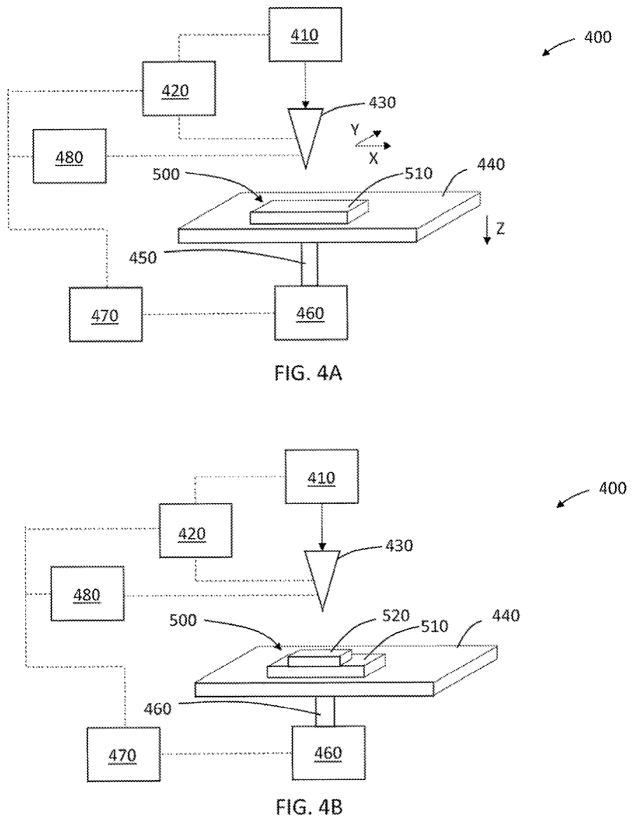

FIGS. 4A-B illustrate additive manufacturing apparatus 400 at different stages of an additive manufacturing process to produce a low T_{g} glass object. The additive manufacturing apparatus 400 includes a source 410 of low T_{g} glass, a nozzle 430 through which the low T_{g} glass may be flowed, and a platform 440 onto which the flowed low T_{g} glass may be deposited. The additive manufacturing apparatus 400 also includes a heater 420 configured to heat the low T_{g} glass in the source 410 or the nozzle 430, or both the source 410 and the nozzle 430 so that the low T_{g} glass may flow through the nozzle 430 and onto the platform 440. The apparatus 400 also includes a controller 470 operably coupled to, and configured to control, the heater 420. The controller 470 may also be operably coupled to motor 480 or other suitable component to move nozzle 430 in a plane parallel to a top surface of the platform 440 so that a layer 510 of the object 500 being formed may be deposited in a predetermined manner, such as in accordance with data regarding the layers of a three-dimensional model that may be stored in memory coupled to the controller 470. In other words, the nozzle 430 may be moved in the “X” and “Y” directions as indicated in FIG. 4A. The controller 470 may also be coupled to motor 460 or other suitable component configured to move the platform 440 closer to, or further from, the nozzle 430. In other words, the motor 460 or other suitable component may cause the platform 440 to move in the “Z” direction shown in FIG. 4A. For example, once the first layer 510 of the low T_{g} glass object 500 is deposited on the platform 440 in the predetermined manner, the platform 440 may be displaced a predetermined distance from the nozzle 430, and a second layer 520 of low T_{g} glass may be deposited on the first layer 510. The process may be repeated until all layers of the low T_{g} glass have been deposited and formation of the object is complete.

In some embodiments. a polymer material may be included in the three dimensional structure comprising glass. The same nozzle used to deposit the glass may deposit the polymer, or a separate nozzle may deposit the polymer. The polymer may form a continuous or discontinuous layer within the three dimensional structure.

The above description illustrates certain embodiments of the present invention and are not to be interpreted as limiting. Selection of particular embodiments, combinations thereof, modifications, and adaptations of the various embodiments, conditions, and parameters normally encountered in the art will be apparent to those skilled in the art and are deemed to be within the spirit and scope of the present invention.

As used herein, the terms “comprises”, “comprising”, and grammatical variations thereof are to be taken to specify the presence of stated features, integers, steps or components or groups thereof, but do not preclude the presence or addition of one or more other features, integers, steps, components, or groups thereof.

1. An additive manufacturing method, comprising:
heating a glass having a glass transition temperature (T_{g}) of about 500° C. or less;
flowing the heated glass through a nozzle onto a platform; and
moving at least one of the nozzle or the platform while the heated glass is flowed through the nozzle onto the platform to form an object on the platform.

2. The additive manufacturing method of claim 1, wherein the glass comprises an alkali phosphate glass.

3. The additive manufacturing method of claim 1, wherein the glass comprises a tin fluorophosphate glass.

4. The additive manufacturing method of claim 1, wherein the glass comprises, on an elemental basis, tin in a mole percentage within a range from 7.4 to 30, fluorine in a mole percentage within a range from 4.9 to 47.2, phosphorus in a mole percentage within a range from 6.7 to 23.1, and oxygen in a mole percentage within a range from 20.8 to 61.5.

5. The additive manufacturing method of claim 1, wherein the glass comprises, on an elemental basis, tin in a mole percentage within a range from 12 to 17.1, fluorine in a mole percentage within a range from 11.2 to 24.3, phosphorus in a mole percentage within a range from 12.1 to 19.6, and oxygen in a mole percentage within a range from 43.3 to 61.1.

6. The additive manufacturing method of claim 1, wherein the glass comprises, on an elemental basis, tin in a mole percentage within a range from 15.4 to 17.1, fluorine in a mole percentage within a range from 19.6 to 24.3, phosphorus in a mole percentage within a range from 14.2 to 16.6, and oxygen in a mole percentage within a range from 43.3 to 56.

7. The additive manufacturing method of claim 1, wherein the glass has a T_{g} of about 300° C. or less.

8. The additive manufacturing method of claim 1, wherein the glass has a T_{g} from about 180° C. to about 280° C.

9. The additive manufacturing process of claim 1, wherein moving at least one of the nozzle or the platform while the while the heated glass is flowed through the nozzle onto the platform comprises dispensing, in a predetermined pattern, a first layer of the heated glass on the platform, displacing the platform a predetermined incremental distance from the nozzle by moving at least one of the nozzle or the platform, and dispensing a second layer of the heated glass on the first layer.

10. The additive manufacturing process of claim 1, wherein moving the nozzle relative to the platform while the heated glass is flowed through the nozzle onto the platform comprises moving at least one of the nozzle or the platform based on a computer-based three-dimensional model of the object being formed on the platform.

11. The additive manufacturing process of claim 1, wherein the nozzle has a temperature from about 80° C. to about 400° C.

12. The additive manufacturing process of claim 1, wherein the nozzle has a temperature from about 10° C. to about 100° C. above the T_{g} of the glass.

13. The additive manufacturing process of claim 1 further comprising depositing a polymer to form the object.

14. The additive manufacturing process of claim 13 wherein the polymer forms a continuous layer.

15. A three-dimensional object manufactured according to the process of claim 1.
